(19) United States
(12) Patent Application Publication
(10) Pub. No.: US 2009/0096184 A1
(43) Pub. Date: Apr. 16, 2009

(54) Bicycle with a Pressurization System

(76) Inventor: Lars Krudenscheidt, Radevormwald (DE)

Correspondence Address: SCHWEGMAN, LUNDBERG & WOESSNER, P.A., P.O. BOX 2938, MINNEAPOLIS, MN, 55402, US

(21) Appl. No.: 12/084,092

(22) PCT Filed: Oct. 19, 2006
(86) PCT No.: PCT/EP2006/010104

§ 371 Date: Apr. 24, 2008

(30) Foreign Application Priority Data
Oct. 26, 2005 (DE) 10 2005 051 284.4

(51) Int. Cl. B62J 11/02; B60C 23/10

(52) U.S. Cl. 280/201; 152/415

(57) ABSTRACT

Proposed is a pressurization system for a bicycle featuring at least one component (18, 20, 24, 28) pressurized by the pressure medium, comprising a pressure source (40) connected to the component (18, 20, 24, 28). In accordance with the invention the pressure source (40) comprises a compressor (72) featuring a sprocket (86) powered by means of a pedal crankset (30) of the bicycle.

The invention relates to a bicycle featuring a pressurization system for at least one air-pressurized component as it reads from the preamble of claim 1.

One such bicycle is known from German patent DE 893 307, it comprising a pressurization system including a pressure source connected to a component of the bicycle pressurized by a gaseous pressure medium. The pressure source comprises a compressor provided with a chain wheel driven by means of a conventional bicycle chain, in other words by means of the pedal crankset of the bicycle. In addition, the pressure source comprises an accumulator section which is gas pressurized by means of a compressor. This pressurization system is secured to the back of the seat tube of the bicycle as a bulky accessory item.

A pressurization system for a bicycle is also known from German patent DE 195 438 A1 serving in this case to raise and lower a bicycle seat. The pressure source in this system is a cartridge-type accumulator cooperating with a piston/cylinder assembly integrated in a frame of the bicycle. The piston/cylinder assembly acts on a seat stay.

It is particularly competition or mountain bikers negotiating plain to difficult terrain that have a need to adapt tyre air pressurization to a particular terrain. However, this requires them to halt and reduce the tyre pressure or to increase it with a bicycle pump. The same problematic situation is involved with pneumatic dampers requiring to be pressurized in accordance with the terrain being negotiated,

The invention is based on the object of provided a generic bicycle as described at the outset which now makes it possible to adjust the gas pressure of a bicycle component pressurized with a gaseous pressure medium without halting.

This object is achieved in accordance with the invention by the bicycle having the pressurization system as featurized in claim 1.

The gist of the invention involves providing a pressure source which can now be activated by actuating a pedal crankset as a component of the a bicycle in any case so that the air pressure existing in the component pressurized by the gaseous pressure medium can be adapted as wanted by the biker in pedalling the bicycle concerned.

The component pressurized by the gaseous pressure medium is, for example, a tyre or its tube or a damper of the bicycle, although it is just as feasible to employ the pressure source for a seat damper, pneumatically actuated shifter, a pneumatically actuated front derailleur, an air brake or the like.

The pressure source is of the cartridge-type accommodated in a seat tube of the bicycle so that a shaft driving the compressor passes through the wall of the seat tube. Fitting such a pressurization system requires drilling a hole in the seat tube of the bicycle in which the compressor drive shaft is inserted. The compressor drive shaft can thus securely locate the cartridge-type pressure source where fitted in the seat tube. As a rule the seat tube is accessible top down.

The compressor is provided furthermore with an air intake port passing through the seat tube into which the pressure source is fitted. This in particular serves, for one thing, to intake air from the environment and, for another, to further safeguard the pressure source in the seat tube.

So that an adequate supply of pressure for pressurizing the corresponding bicycle component is always available, the pressure source has an accumulator section for pressurization with a gas pressure by means of the compressor which in this case pumps the gas, as a rule air, into the accumulator section which then makes the corresponding gas pressure available for the component concerned when required.

To maintain the gas pressure existing in the accumulator section constant there is disposed preferably between the compressor and the accumulator section a control valve which is activated when the wanted pressure in the accumulator section is attained. In particular it switches the compressor in its delivery phase to return the intaken air to the environment, resulting in no increase in the pedalling resistance, whereas when the gas pressure in the accumulator section drops below the wanted pressure, as is usually the case after having pressurized the component with the pressure medium, the control valve connects the compressor to the accumulator section so that the accumulator section can be repressurized with the wanted pressure.

As an alternative, or in addition thereto, a coupling can be disposed between the pedal crankset and the compressor which uncouples the accumulator section when the wanted pressure is attained. Such a coupling is particularly a pneumatically actuated coupling which when uncoupled deactivates the compressor. The sprocket of the compressor freewheels with the pedal crank when the coupling is uncoupled.

To prevent the compressor from malfunctioning due to the intake air being polluted with particles a filter is preferably incorporated in the air intake port which can also prevent condensate forming in the system.

So that the biker can retrieve the gas pressure available in the pressure source a manual actuator is included in a conduit connecting the pressure source and the bicycle component pressurized by the pressure medium.

The manual actuator preferably comprises a rocker selector by means of which the gas pressure in the corresponding component can be increased or decreased.

The manual actuator preferably provided for attachment to the handlebars of the bicycle and accordingly featuring a suitable clip or the like, preferably comprises at least one pressure gauge furnishing an indication as to the gas pressure existing in the component concerned.

To prevent the component concerned being damaged by the pressure medium being overpressurized, the pressurization system in accordance with the invention needs to include at least one pressure relief valve.

The pressurization system of the bicycle in accordance with the invention may serve to set the gas pressure of several bicycle components pressurized by the gaseous pressure medium, it being expedient in this case to provide a distributor means connected, on the one hand, to input the pressure source comprising the compressor and, on the other, to output several outlet ports or passageways to the corresponding bicycle components.

When the component pressurized by the pressure medium, connected to the pressure source of the pressurization system, is a tyre of a bicycle wheel, expediently the wheel includes a sealed hub in the axle of which an air conduit is ported secured to the frame and fork and which is connected radially to an air conduit rotating relative to the hub axle and leading to the tyre or its tube.

The compressor is driven preferably by means of a ribbed belt connecting the sprocket of the compressor and the pedal crankset of the bicycle. This then makes it necessary to provide a gearwheel at the pedal crankset, especially at the side of the pedal crankset facing away from the chain leaves, mating with the ribbed belt. Instead of a ribbed belt it is of course, just as possible to provide a chain or a vee belt. In the latter case, instead of gearwheels belt pulleys are employed between which the vee belt is tensioned.

Further advantages and advantageous aspects of the subject matter in accordance with the invention read from the description and claims as shown in the drawing.

Two example aspects of the subject matter of the invention will now be detailed in the following description as shown simplified diagrammatically in the drawing in which:

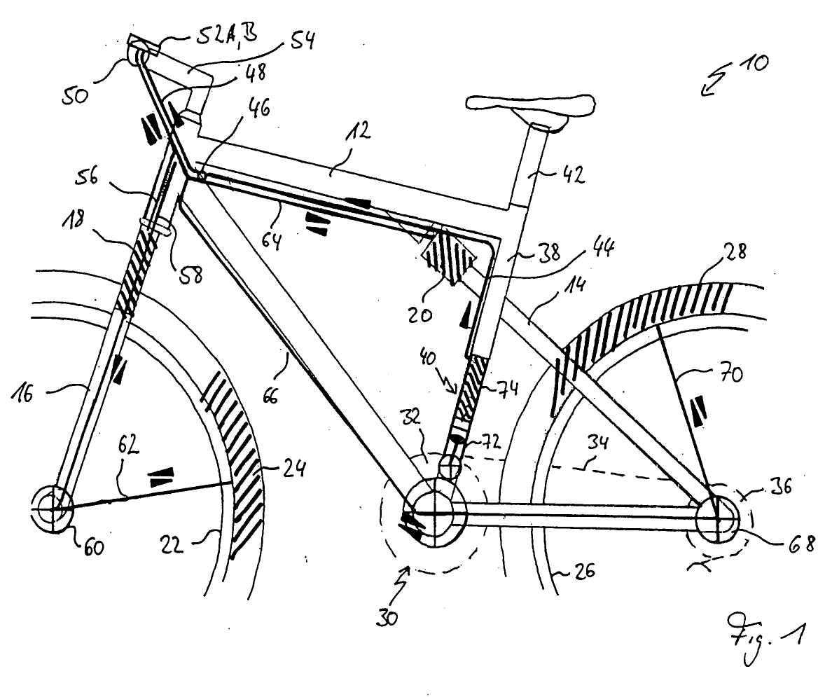

FIG. 1 is a view of a bicycle including a pressurization system in accordance with the invention;

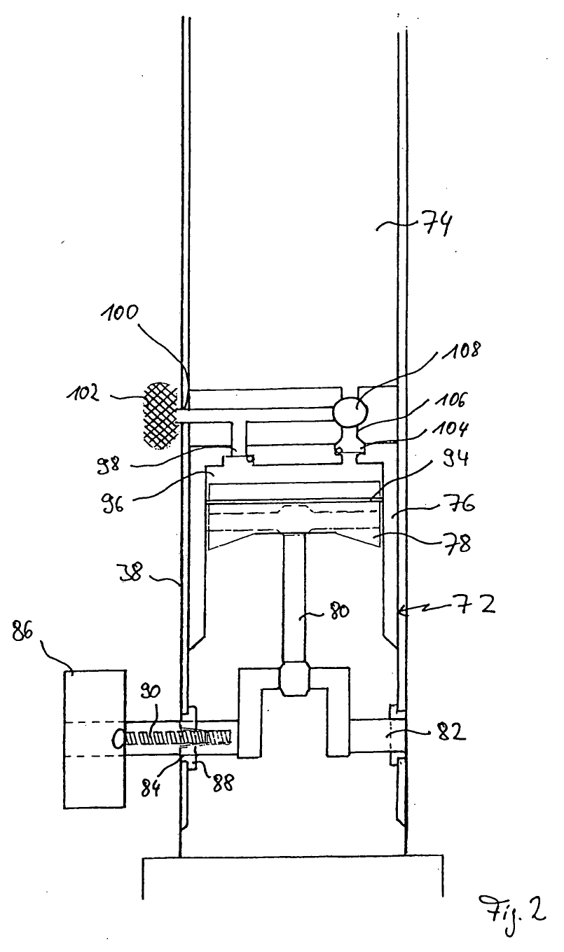

FIG. 2 is a view of a pressure source of the pressurization system;

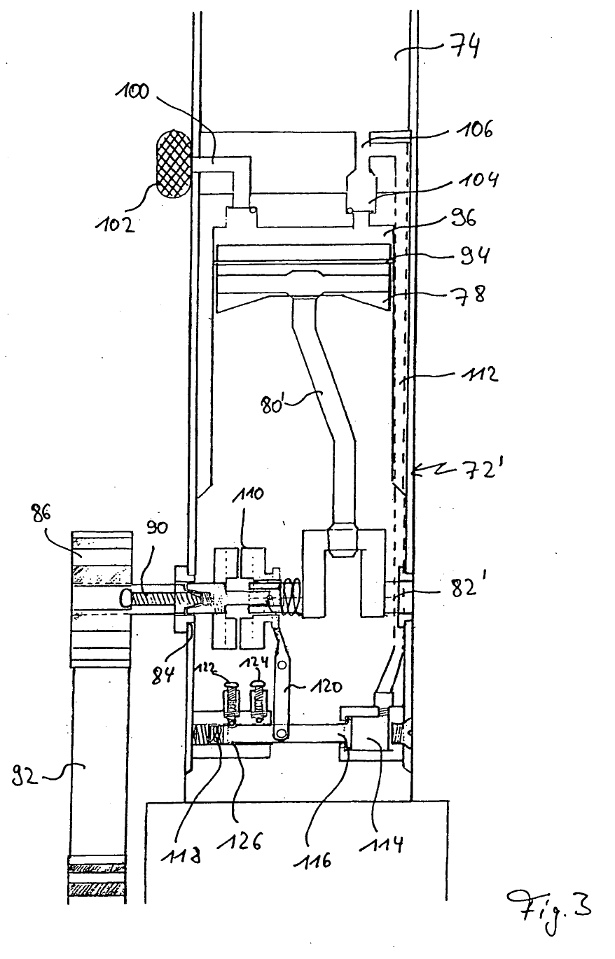

FIG. 3 is a view of an alternative embodiment of a pressurization system;

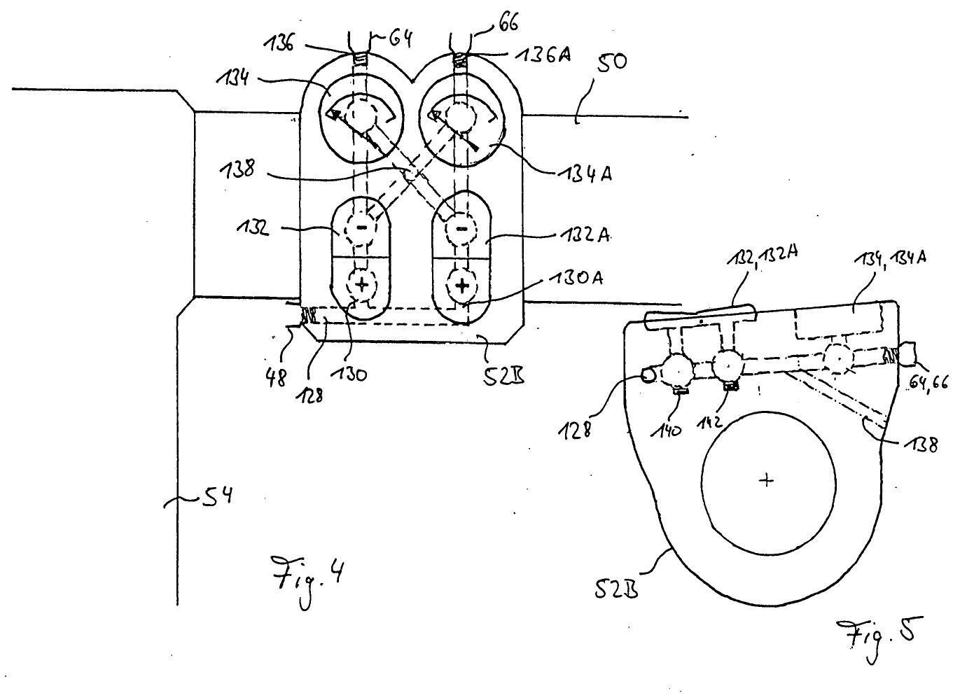

FIG. 4 is a top-down view of a manual actuator of the pressurization system;

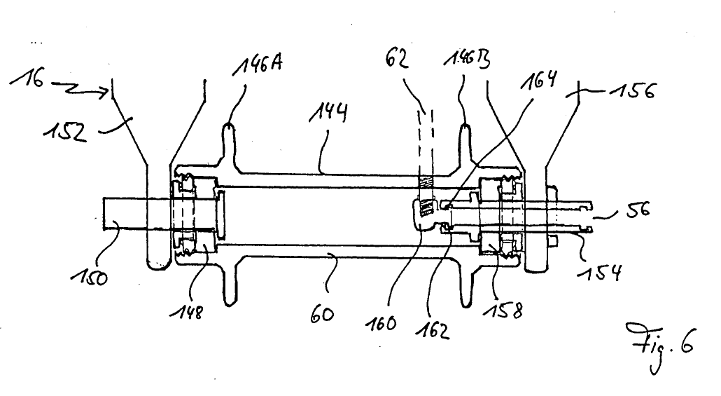

FIG. 5 is a section view through the manual actuator as shown in FIG. 4; and

FIG. 6 is a section view through a wheel hub of the bicycle as shown in FIG. 1.

Referring now to FIG. 1 there is illustrated a bicycle 10 in the form of a mountain bike comprising a frame 12 featuring a pivot-mounted rear structure 14 as well as a spring fork 16. The spring fork 16 includes a damper 18. The rear structure 14 likewise features a damper 20. In addition the bicycle 10 comprises a front wheel 22 with a front tyre 24 and a rear wheel 26 with a rear tyre 28. The damper 18 of the spring fork 16, the rear damper 20, front tyre 24 and rear tyre 28 each represent a component of the bicycle 10 pressurized by gaseous pressure medium.

In addition, the bicycle 10 is powered as usual by a pedal crankset 30 acting via chain rings 32 and a chain 34 on a cartridge 36 comprising a pinion, the cartridge 36 being attached to the rear wheel 26.

Integrated in a seat tube 38 of the frame 12 is a pressure source 40 for a gaseous pressure medium, in the present case, air, structured as a cartridge for insertion top down into the seat tube 38 with the seat stay 42 removed.

The pressure source 40 is connected by a pressure conduit 44 to a distributor 46 featuring two outlet passageways, each of which fluidly communicates via conduit 48 to a manual actuator 52A and 52 B respectively secured to the handlebars 50 (see FIGS. 4 and 5 for more details). The manual actuator 52A is secured on the left-hand side of a leading mount 54 to the handlebars 50. The manual actuator 52B is secured on the right-hand side of a leading mount 54 to the handlebars 50.

Branching off from the left-hand manual actuator 52A are two conduits 56 and 58, the conduit 56 fluidly communicating with the damper 18 and the conduit 58 via a wheel hub 60 with a conduit 62 connecting the front tyre 24.

Branching off from the right-hand manual actuator 52B is a conduit 64 fluidly communicating with the rear damper 20, and a conduit 66 fluidly communicating with a rear wheel hub 68 from which a conduit 70 branches off to fluidly communicate with the rear tyre 28 of the rear wheel 26.

Referring now to FIG. 2 there is illustrated in particular how the pressure source 40 comprises a compressor 72 and an accumulator section 74 in which air compressed by means of the compressor 72 can be made available at a wanted pressure.

The compressor 72 comprises, guided in a cylinder 76, a piston 78 connected by a piston rod 80 to a crankshaft or drive shaft 82 passing through a hole 84 drilled in the seat tube 38 with a sprocket 86 configured as a pinion for driving the compressor 72. In the region of the hole 84 drilled in the seat tube 38 the drive shaft 82 is rotatably mounted by a bearing 88.

The sprocket 86 is bolted to the drive shaft 82 by a bolt 90 and connected by a ribbed belt 92 to a toothed wheel (not shown) located on the side of the crank bearing of the pedal crankset 30 facing away from the chain rings 32.

The piston 78 comprising a circumferential sliding seal 94 defines by its face facing away from the piston rod 80 a compression chamber 96 connected by an inlet valve 98 to an air intake port 100 passing through the seat tube 38, seating a air filter 102. Branching off via an outlet valve 104 from the compression chamber 96 is furthermore an outlet conduit 106 fluidly communicating with the accumulator section 74.

In the outlet (pressure) conduit 106 there is inserted a control valve 108 which switches as a function of the pressure existing in the accumulator section 74 such that when a wanted pressure in the accumulator section 74 of the compressor 72 is exceeded, compressed air is not fluidly communicated into the accumulator section 74 but via a conduit 110 to the air intake port 100 and from there to the environment.

Referring now to FIG. 3 there is illustrated an alternative embodiment of a pressure source for installing in a seat tube 38 of a bicycle. The pressure source as shown in FIG. 3 comprises, the same as the embodiment as shown in FIG. 2, a compressor 72′ comprising a piston 78 guided in a cylinder 76. In this case the piston 78 is connected by a cranked piston rod 80′ to a drive shaft 82′ serving as the shaft driving the piston 78 and passing through the seat tube 38. Mounted on the drive shaft 82′ outside of the seat tube 38 is a sprocket 86 and bolted in place by means of a bolt 90. Configured furthermore in the region of a hole 84 drilled in the seat tube 38 is a bearing 88 for the drive shaft 82′.

The drive shaft 82′ is provided with a pneumatically actuated coupling 110 which is uncoupled and coupled as a function of the air pressure existing in the accumulator section 74 in thus controlling the stroke of the piston 78. For this purpose there branches from a outlet conduit 106 branching from the compression chamber 96 of the compressor 72′ a control conduit 112 fluidly communicating a pressure space 114 in which a piston 116 is axially slidingly guided as biased by means of a spring 118. Pivot-mounted at the piston 116 is a lever 120 which uncouples and couples respectively the coupling 110 as a function of the position of the piston 116, i.e. of the pressure existing in the pressure space 114. To secure the two switching positions of the piston 116 latching members 122 and 124 are furthermore provided, each of which is spring loaded in cooperating with an annular groove 126 of the piston 116.

Referring now to FIGS. 4 and 5 there is illustrated the right-hand manual actuator 52B assigned to the rear damper 20 and the rear tyre 28. The manual actuator 52B has a inlet passageway 128 into which the conduit 48 branched off from the distributor 46 ports. Branching off from the inlet passageway 128 is a first control passageway 130 provided with a first switch rocker 132 followed by a first pressure gauge 134 fluidly communicating with a first outlet passageway 136 connected to the conduit 64 fluidly communicating with the rear damper 20. Furthermore, branching off from the inlet passageway 128 is a second control passageway 130A featuring a second switch rocker 132A followed by a second pressure gauge 134A fluidly communicating with a second outlet passageway 136A connected to the conduit 66 fluidly communicating with the rear wheel 26.

Each of the switch rockers 132 and 132A is designed with a key marked “+” and a key marked “−” pressing which increases and reduces the pressure of the compressed air existing in the assigned component 20 and 28 respectively. Pressing the key marked “−” of the switch rockers 132 and 132A exhausts air via a pressure relief conduit 138 from the manual actuator 52B.

The switch rockers 132, 132A are maintained neutrally positioned by means of spring members 140 and 142 meaning there is no regulation of the air pressure in each of the pressurized components 20 and 28.

The manual actuator 52A for the air pressure in the damper 18 of the spring fork 16 and the air pressure in the front tyre 24 is correspondingly designed.

Referring now to FIG. 6 there is illustrated the wheel hub 60 of the front wheel 22 serving to fluidly communicate the air redirected from the conduit 58 to the conduit 62 connecting the pressure space of the front tyre 24, and vice-versa. For this purpose the wheel hub 60 has a tubular hub shell 144 comprising two ring shoulders 146A and 146B for attaching spokes. At the side, shown on the left in FIG. 6 the hub shell 144 is rotatably connected via a bearing 148 to a bush 150 serving as an axle and via which the wheel hub 60 can be clamped in place to a leg 152 of the spring fork 16. At the side facing away from the bush 150 the wheel hub 60 comprises tubular sleeve 154 serving as an axle. Porting into the sleeve is the conduit 56 fixed to the frame and fork respectively and which is non-rotatably secured to a second leg 156 of the fork. Located at the sleeve 154 is a bearing 158 via which the hub shell 144 is rotatably connected to the sleeve 154.

Fitted in the sleeve 154 at the side facing away from the conduit 56 is an elbow 160 rotatably seal mounted in an annular groove 162 by means of a annular shoulder 164 and engaging the conduit 62 passing through the hub shell 144 and fluidly communicating with the front tyre 24.

Not shown, but which may also be provided, is a condensate drain plug.

1. A bicycle comprising;
a frame with a seat tube;
at least one component pressurized by a gaseous pressure medium as;
a pressurization system comprising a pressure source connected to the component, the pressure source comprising a compressor provided with a sprocket operable to be powered by means of a pedal crankset of the bicycle;
the pressurization system including an accumulator section operable to be pressurized by the compressor with a gas pressure,
wherein the pressure source is configured as a cartridge such that the compressor and the accumulator section fit in the seat tube of the frame; and
a drive shaft of the compressor is provided with an air intake port passing through the seat tube.

2. The bicycle as set forth in claim 1, wherein a control valve is disposed between the compressor and the accumulator section, the control valve operable to switch when a wanted pressure is attained in the accumulator section.

3. The bicycle as set forth in claim 1, including a coupling disposed between the pedal crankset and the compressor which uncouples when a wanted pressure is attained in the accumulator section.

4. The bicycle as set forth in claim 1, wherein the air intake port includes an air filter.

5. The bicycle as set forth in claim 1, characterized in that at least one manual actuator is arranged in at least one of a plurality of conduits connecting the pressure source and the at least one component operable to be pressurized by the pressure medium.

6. The bicycle as set forth in claim 5, wherein manual actuator comprises at least one switch rocker.

7. The bicycle as set forth in claim 5, wherein the manual actuator comprises at least one pressure gauge.

8. The bicycle as set forth in claim 5, wherein the manual actuator is secured to a handlebar.

9. The bicycle as set forth in claim 1, including at least one pressure relief valve fluidly communicated to the accumulator section.

10. The bicycle as set forth in claim 1, including a distributor for a plurality of components pressurized by the pressure medium.

11. The bicycle as set forth in claim 1, wherein the component operable to be pressurized by the pressure medium is a tire of a bicycle wheel.

12. The bicycle as set forth in claim 11, wherein the bicycle wheel comprises a gas-tight hub the axle of which is ported by an air conduit fixed to the frame or to a fork and which is radially connected to an air conduit rotating relative to the hub axle and fluidly communicating with a pressure space of the tire.

13. The bicycle as set forth in claim 1, wherein the component operable to be pressurized by the pressure medium is a chassis damper of the bicycle.

14. The bicycle as set forth in claim 1, wherein the compressor is operable to be powered by a ribbed belt connecting the sprocket of the compressor and the pedal crankset.

15. A bicycle comprising:
a frame including a seat tube;
at least one component coupled to the frame, the component operable to be pressurized by a gaseous pressure medium;
a pedal crankset mounted on the frame;
a sprocket connected to the pedal crankset and operable to be powered by the pedal crankset;
a pneumatically actuated coupling connected to the sprocket;
a compressor coupled to the pneumatically actuated coupling and operable to be powered through the pneumatically actuated coupling, the compressor including
a drive shaft coupled to the pneumatically actuated coupling,
a cranked piston rod coupled to the drive shaft, and
a piston guided in a cylinder, the piston coupled to the cranked piston rod;
an accumulator fluidly coupled to the compressor and operable to be pressurized with the gaseous pressure medium provided by the compressor, the accumulator operable to be selectively coupled to the component and to pressurize the component using the gaseous pressure medium when the accumulator is selectively coupled to the component;
wherein the pneumatically actuated coupling, the compressor, and the accumulator are all fitted within the seat tube of the bicycle; and
wherein the pneumatically actuated coupling is operable to mechanically couple and uncouple the drive shaft and the sprocket as a function of a pressure in the accumulator.

16. The apparatus of claim 15, further including:
a second piston fluidly coupled to the accumulator and biased by a spring; and
a lever coupled to the second piston, the lever operable to actuate the pneumatically actuated coupling to mechanically couple and uncouple the sprocket and the drive shaft as a function of a position of the second piston,
wherein the position of the second piston is a function of a pressure in the accumulator.

17. The apparatus of claim 16, wherein the second piston and the lever are fitted inside the seat tube.

18. The apparatus of claim 16, including a plurality of latching members, each of the latching members spring loaded and operable to engage with an annular groove in the second piston, wherein each of the latching members, when engaged in the annular groove, secure the second piston in one of two switching positions,
wherein a first of the two switching positions actuates the lever to mechanically couple the sprocket and the drive shaft through the pneumatically actuated coupling, and a second of the two switching positions actuates the lever to mechanically uncouple the sprocket from the drive shaft using the pneumatically actuated coupling.
